(19) United States
(12) Patent Application Publication
(10) Pub. No.: US 2005/0073960 A1
(43) Pub. Date: Apr. 7, 2005

(54) Data transfer system capable of precisely deciding transfer rate

(76) Inventors: Satoshi Oura, Fukushima-ken (JP); Takuya Nishimura, Fukushima-ken (JP)

Correspondence Address: BRINKS HOFER GILSON & LIONE, P.O. BOX 10395, CHICAGO, IL, 60610, US

(21) Appl. No.: 10/642,066

(22) Filed: Aug. 15, 2003

(30) Foreign Application Priority Data
Aug. 27, 2002 (JP) 2002-247272

(51) Int. Cl. H04L 12/26

(52) U.S. Cl. 370/252; 370/232

(57) ABSTRACT

When a center transfer rate of three kinds of transfer rates having transfer speeds thereof adjacent to one another and to be used in a next cycle time is selected within a certain predetermined cycle time on the basis of throughput obtained at each of the three transfer rates as a result of data transfer at the three transfer rates the center transfer rate of the three transfer rates to be used within the next cycle time is selected by considering also whether or not a packet loss ratio in the data transfer in that cycle time exceeds a stipulated value.

### BACKGROUND OF THE INVENTION

1. Field of the Invention

This invention relates to a data transfer method. More particularly, the invention relates to a data transfer method for optimizing data transfer rate selection in wireless LAN.

2. Description of the Related Art

A technology stipulated by IEEE802.11a, for example, is known as a prior art technology relating to wireless LAN that uses a 5 GHz band. The prior art technology can use 6 Mbps to 54 Mbps as a transfer rate and selects one of a plurality of predetermined transfer rates depending on data communication quality between network terminals that execute data transmission and reception.

FIG. 2 of the accompanying drawings is a table useful for explaining the transfer rates stipulated by IEEE802.11a and FIG. 3 is a graph useful for explaining an example of a relation between a transfer distance at some of the stipulated transfer rates and throughput. The relation of the stipulated transfer rate and transfer distance and the throughput will be first explained with reference to FIGS. 2 and 3.

As shown in FIG. 2, the transfer rates in wireless LAN using the 5 GHZ band in accordance with IEEE802.11a are 6 Mbps, 9 Mbps, 12 Mbps, 18 Mbps, 24 Mbps, 36 Mbps, 48 Mbps and 54 Mbps. A modulation system and a code rate for use of each of these transfer rates are also determined as shown in FIG. 2.

When data communication is made between the network terminals through wireless LAN according to the prior art technology described above, on the other hand, instability of the line is likely to occur owing to collision resulting from simultaneous transmission of communication packets, circuit disconnection resulting from connection outside a service area and fading resulting from multi-paths created by reflection by obstacles, ground or floor. The collision resulting from simultaneous transmission of the communication packets from both terminals can be avoided when the terminals making data transmission and reception set different waiting time and execute re-transfer processing, or when carrier detection is made before transmission and a collision preventive measure is thus taken in advance. Instability of the line resulting from fading can be avoided by the steps of conducting transfer rate optimization for selecting the optimum transfer rate to secure an optimum communication state, adding rate information to a header of the packet to modulate the transfer data and causing the reception side to conduct demodulation in accordance with the rate information. The transfer method in wireless LAN according to the prior art technology can thus acquire maximum transfer performance by conducting optimization for selecting the optimum transfer rate.

In the example of the relation between the transfer distance and the throughput shown in FIG. 3, stable data transfer can be conducted within a range of the transfer distance of 30 m at the transfer rates of 12 Mbps and 18 Mbps without inviting instability of the line due to fading. When the transfer rates are 48 Mbps and 54 Mbps, however, a drastic drop of throughput occurs within the range of about ±2 m with the transfer distance of 15 m as the center and within the range of the transfer distance of 26 m or more. Incidentally, the example shown in FIG. 3 represents the throughput of the transfer distance of up to 30 m, but the transfer distance at stipulated transmission power in wireless LAN using the 5 GHz band is maximum about 100 m. In the example shown in FIG. 3, the distance at which the drop of throughput occurs with a high transfer rate exists at the positions of 15 m and 26 m or more. However, this position varies from the nature of the transfer path of the radio wave depending on the conditions of various obstacles existing inside the area constituting LAN, the height of an antenna of the terminal on the transmission side, and so forth.

Throughput can be increased much more generally when the transfer rate becomes higher, and data transfer can be made more efficiently. In this case, because multi-value coding becomes necessary, data transfer becomes weak against noise and influences of fading becomes greater as can be appreciated from FIG. 3. This problem occurs particularly when one, or both, of the network terminals conducting data transfer are moving. It is therefore essential to always select a transfer rate providing the highest efficiency and to conduct the data transfer at that rate.

FIG. 4 is an explanatory view useful for explaining a data transfer sequence between network terminals in the prior art technology as well as in the present invention. FIG. 5 is a flowchart useful for explaining a switching method of the transfer rate according to the prior art technology. Next, switching of the transfer rate according to the prior art technology will be explained with reference to FIGS. 4 and 5.

It will be assumed hereby that a data transmission request exists at a terminal A and data are transmitted from the terminal A to a terminal B. In this case, the terminal A uses a transfer rate optimized by the data transfer that has been made so far as a reference transfer rate and modulates transmission data by a modulation system determined at that transfer rate to create a packet. After the transfer rate information is added to the packet, the terminal A transmits the packet to the terminal B. When the terminal B on the reception side is able to complete reception of the transmitted packet without an error, the terminal B transmits a reception acknowledgement notice Ack packet to the terminal A on the transmission side in response to the packet transmitted.

When the terminal A on the transmission side fails to receive the Ack packet within a predetermined time after its transmission of the packet, it transmits again the same packet. This re-transmission processing can be executed by means of software, hardware, or their combination. The number of times of re-transmission is not particularly limited but is from 10 to 15 times from the aspect of the delay time of the packet.

When the terminal A on the transmission side is able to receive the Ack packet within the range of the number of times of re-transmission described above, it transmits next transmission data to the terminal B on the reception side in the same way as described above by modulating the next transmission data at a transfer rate higher by one than the reference transfer rate (reference transfer rate+1), such as a transfer rate of 36 Mbps when the reference transfer rate is 24 Mbps. Further, the terminal A on the transmission side transmits next transmission data by modulating it at a transfer rate lower by one than the reference transfer rate (reference transfer rate−1), such as a transfer rate of 18 Mbps when the reference transfer rate is 24 Mbps.

The terminal A on the transmission side consecutively repeats transmission of the packets at the three transfer rates adjacent to one another, that is, the reference transfer rate, the reference transfer rate+1 and the reference transfer rate−1 as described above, for a predetermined time that is in advance determined as a cycle time. Throughput performance for each time is calculated for each of the reference transfer rate, the reference transfer rate+1 and the reference transfer rate−1, and decides the reference transfer rate of the data transmission in the next cycle time.

In the data transmission described above, data communication is started under the initial state of the start of communication at the lowest transfer rate (a rate at which connection of communication can be reliably established), that is, the transfer rate of 6 Mbps in the example shown in FIG. 2, as the reference transfer rate.

Throughput performance can be calculated as [throughput performance=number of completed packets/time] from the number of packets for which communication is completed and from the time calculated from the transfer rate. Generally, the data amount required is variable. The maximum data size that can be transmitted once is 1,500 bytes inclusive of a header and a payload, and the data size is divided into a long length type having maximum 1,500 bytes and a short length type having maximum 500 bytes. Calculation described above is conducted in the same way as described above for each of these two data sizes.

When one cycle time finishes, the terminal A on the transmission side calculates the throughput performance described above for each of the three transfer rates, and selects and decides the reference transfer rate for the next cycle time on the basis of the calculation result.

Next, a method of deciding the reference transfer rate to be used as the center transfer rate in the next cycle time will be explained with reference to the flowchart of FIG. 5.

(1) After one cycle time finishes, the terminal A on the transmission side temporarily holds throughput at each of the three transfer rates as described above, compares the throughput at the reference transfer rate with the product of throughput of the next high order transfer rate by a throughput stipulation ratio and judges whether or not this product value is greater than the throughput at the reference transfer rate (Step 401).

(2) When the product of throughput at the next high order transfer rate by the stipulation ratio is found greater than the throughput of the reference transfer rate as a result of judgment of Step 401, the high order transfer rate in this cycle time is decided as the reference transfer rate in the next cycle time (Step 402).

(3) When the product of throughput at the high order transfer rate by the stipulation ratio is not found greater than the throughput of the reference transfer rate as a result of judgment of Step 401, the throughput at the reference transfer rate is compared with the product of throughput at the next low order transfer rate by the stipulation rate, and whether or not this product value is greater than the throughput at the reference transfer rate is judged (Step 403).

(4) When the product of throughput at the low order transfer rate by the stipulation ratio is found greater than the throughput of the reference transfer rate as a result of judgment of Step 403, the low order transfer rate in this cycle time is decided as the reference transfer rate in the next cycle time (Step 404).

(5) When the product of throughput at the low order transfer rate by the stipulation ratio is not found greater than the throughput at the reference transfer rate as a result of judgment of Step 403, the reference transfer rate in this cycle time is as such used as the reference transfer rate in the next cycle time (Step 405).

Incidentally, the stipulation ratios for multiplying the high and low order transfer rates in the processing of Steps 401 and 403 are set to different values, respectively. These values may be either stored or may be prepared as a table in advance. Because the stipulation ratios for multiplying the high and low order transfer rates are different in this way, hysteresis can be imparted to characteristics when the throughput changes in the up or down direction. Consequently, it becomes possible to prevent the operation from getting unstable when the transfer rate is switched in the proximity of the threshold value.

As described above, in the data transfer method in wireless LAN according to the prior art technology, the transfer rate is decided by merely comparing throughput at different transfer rates, and the center transfer rate in the next cycle time is decided on the basis of the comparison result. In consequence, data transfer can be made at transfer rates having an optimum transfer rate as their center.

The prior art technology described above is not free from the problem that it cannot easily decide a precise transfer rate against drastic fluctuation of a reception sensitivity and fading occurring time-wise, though it can precisely decide the transfer rate for relatively gentle fluctuation of throughput.

### SUMMARY OF THE INVENTION

In view of the problem of the prior art technology described above, it is an object of the present invention to provide a data transfer method capable of precisely deciding a transfer rate against drastic fluctuation of a reception sensitivity and fading occurring time-wise.

In a data transfer method for selecting an optimum transfer rate in accordance with a communication condition to conduct communication, the object of the invention described above can be accomplished by a data transfer method wherein, when a center transfer rate of three kinds of transfer rates having transfer speeds adjacent to one another and to be used in a next cycle time is selected on the basis of throughput at each transfer rate as a result of data transfer at the three transfer rates within a predetermined cycle time, the center transfer rate of the three transfer rates to be used within a next cycle time is selected in consideration of a packet loss ratio in the data transfer within the cycle time.

### BRIEF DESCRIPTION OF THE DRAWINGS

FIG. 1 is a flowchart for explaining a transfer rate switching method according to an embodiment of the invention;

FIG. 2 is a table for explaining transfer rates stipulated by IEEE802.11a;

FIG. 3 is a graph for explaining an example of the relation between a transfer distance at some of the stipulated transfer rates and throughput;

FIG. 4 is an explanatory view for explaining a data transfer sequence between network terminals in the prior art as well as in the invention; and

FIG. 5 is a flowchart for explaining a transfer rate switching method in the prior art.

### DESCRIPTION OF THE EMBODIMENT

A data transfer method according to an embodiment of the invention will be hereinafter explained in detail with reference to the accompanying drawings.

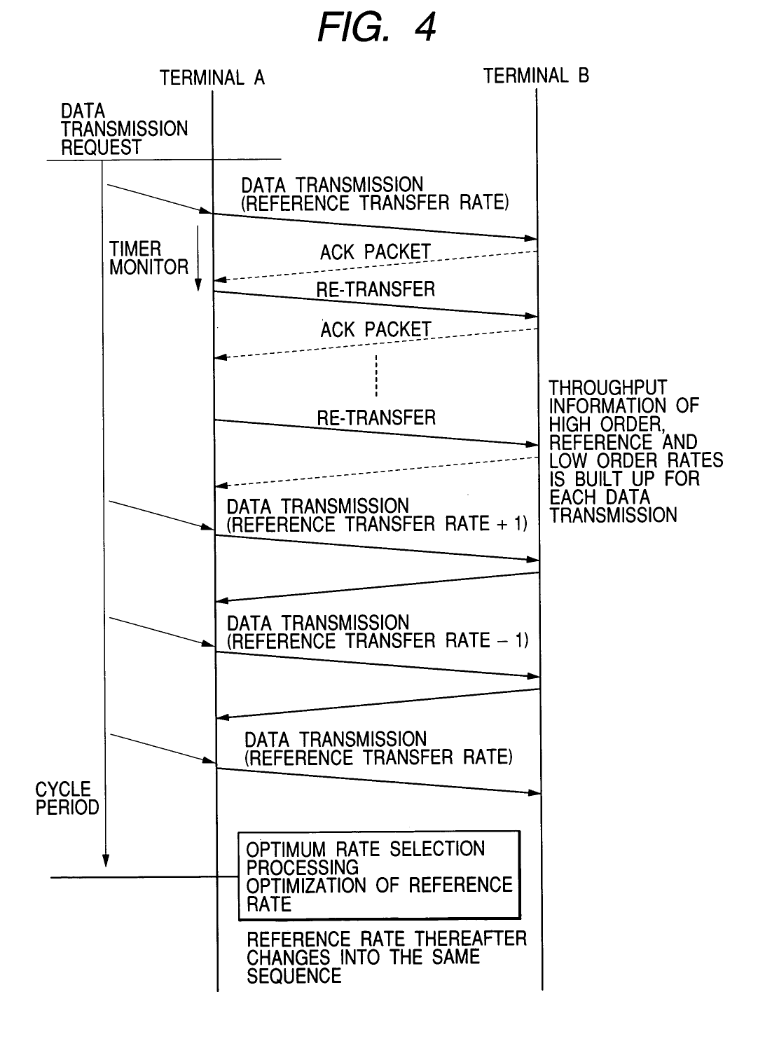

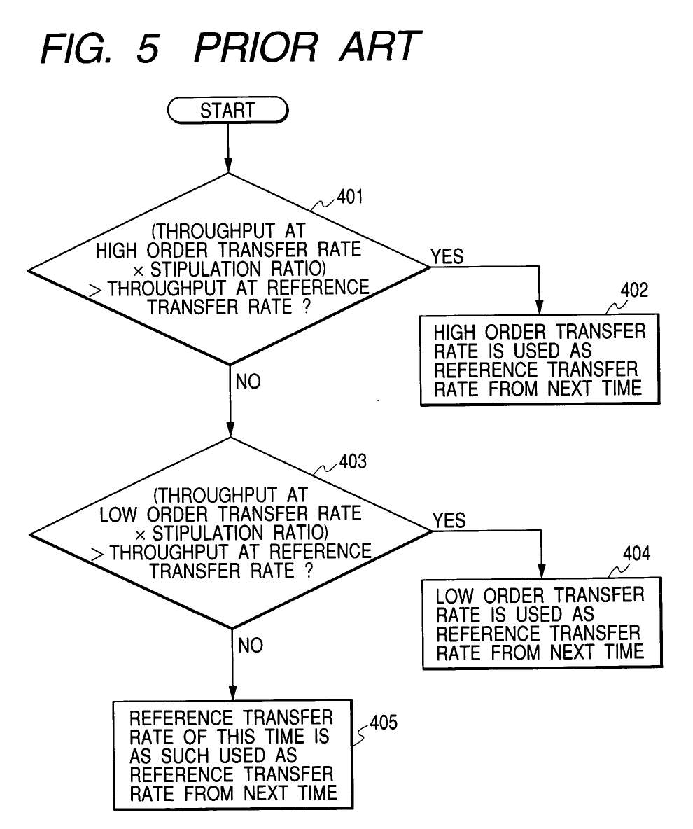

In the sequence of data transfer between the network terminals explained with reference to FIG. 4, a main cause of the packet loss is presumably collision of the packets when the number of times of data re-transfer is 3 or less. When the number of times of data re-transfer exceeds 3, a main cause is presumably a drop of signal quality resulting from deterioration of a radio wave condition, though the packet loss due to collision of the packets is included, too.

Therefore, the embodiment of the invention takes the number of times of re-transfer into account in addition to throughput at each transfer rate at the time of switching of the transfer rate. When the number of times of re-transfer exceeds a predetermined number of times, re-transfer is judged as being greater than the number of time of re-transfer resulting from the collision factor, hence from deterioration of the radio wave condition, so that the rise of the transfer rate is suppressed and the transfer rate is corrected to a low order transfer rate. Therefore, the embodiment of the invention calculates the packet loss ratio in addition to throughput at each transfer rate, and selects and decides the reference transfer rate in the next cycle time. When the number of normal transmission of the packets is “0”, the embodiment of the invention selects the transfer rate so as to lower the reference transfer rate because one of the network terminals is completely out of the service area or the data transmission request does not exist.

The packet loss ratio can be calculated from the number of times of re-transmission. More concretely, the packet loss ratio can be calculated as [total number of transmission packets that cannot be transmitted normally divided by total number of transmission packets×100] from the total number of transmission packets and the number of packets that cannot be transmitted normally (total number of transmission packets−number of packets transmitted normally). The embodiment of the invention uses a value having the number of times of re-transfer of 3 or more and a packet loss ratio of 50% as a stipulation value for transfer rate switching in the next cycle time. The stipulation value of the packet loss ratio is not limited to the value described above but can be set to a more appropriate value depending on an environment in which wireless LAN is constituted.

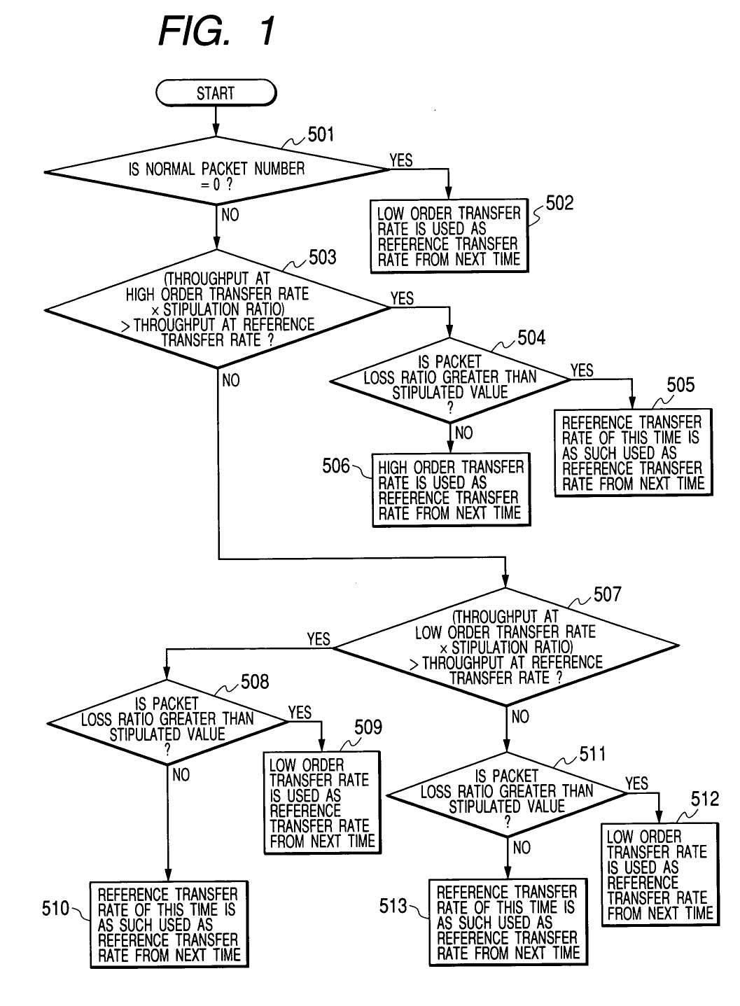

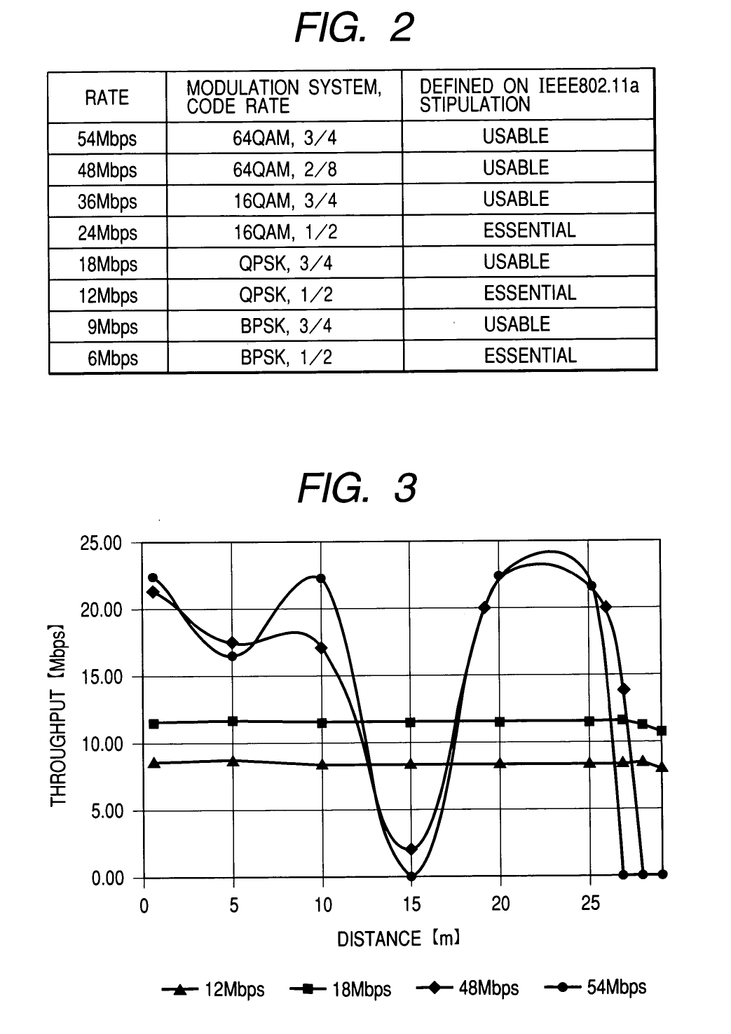

FIG. 1 is a flowchart useful for explaining the transfer rate switching method according to the embodiment of the invention. Next, transfer rate switching in the embodiment of the invention will be explained with reference to this flowchart.

(1) After one cycle time finishes, the terminal A on the transmission side temporarily holds throughput at each of the three transfer rates in the same way as in the prior art technology explained above, calculates the overall packet loss ratio, temporarily holds the calculation results and judges whether or not the number of packets normally transmitted is “0” (Step 501).

(2) When the number of the packets normally transmitted is found “0”, in the judgment of Step 501, the low order transfer rate in the cycle time of this time is decided as the reference transfer rate in the next cycle time (Step 502).

(3) When the number of the packets normally transmitted is not “0” in the judgment of Step 501, the throughput at the reference transfer rate is compared with the product value of throughput of the next high order transfer rate by the stipulation ratio, and whether or not the product value of throughput of the next high order transfer rate by the stipulation ratio is greater than the throughput at the reference transfer rate is judged (Step 503).

(4) When the product value of throughput of the next high order transfer rate by the stipulation ratio is found greater than the throughput at the reference transfer rate in the comparison of Step 503, whether or not the packet loss ratio exceeds the stipulated value is judged (Step 504).

(5) When the packet loss ratio is found greater than the stipulated value in the judgment of Step 504, the reference transfer rate in the cycle time of this time is as such decided as the reference transfer rate in the next cycle time. When the packet loss ratio is not greater than the stipulated value, the next high order transfer rate of this cycle time is decided as the reference transfer rate in the next cycle time (Steps 505 and 506).

(6) When the product value of th roughput of the high order transfer rate by the stipulation ratio is not greater than the throughput at the reference transfer rate in the judgment of Step 503, the throughput at the reference transfer rate is compared with the product value of throughput at preceding low order transfer rate, and whether or not the throughput at the low order transfer rate by the stipulation ratio is greater than throughput at the reference transfer rate is judged (Step 507).

(7) When the product value of throughput of the low order transfer rate by the stipulation ratio is greater than the throughput at the reference transfer rate in the judgment of Step 507, whether or not the packet loss ratio is greater than the stipulated value is judged (Step 508).

(8) When the packet loss ratio is greater than the stipulated value in the judgment of Step 508, the low order transfer rate in this cycle time is decided as the reference transfer rate in the next cycle time. When the packet loss ratio is not greater than the stipulated value, the reference transfer rate in this cycle time is as such decided as the reference transfer rate in the next cycle time (Steps 509 and 510).

(9) When the product value of throughput of the low order transfer rate by the stipulation ratio is greater than the throughput at the reference transfer rate in the judgment of Step 507, whether or not the packet loss ratio is greater than the stipulated value is judged (Step 511).

(10) When the packet loss ratio is greater than the stipulated value in the judgment of Step 511, the low order transfer rate in this cycle time is decided as the reference transfer rate in the next cycle time. When the packet loss ratio is not greater than the stipulated value, the reference transfer rate in this cycle time is as such decided as the reference transfer rate in the next cycle time (Steps 512 and 513).

Incidentally, the stipulation ratios used for multiplication of throughput of the high and low order transfer rates in the processing of Steps 503 and 507 described above are set to mutually different values in the same way as in the prior art technology, and these values may be stored in advance or may be prepared as a table. Because the stipulation ratios used for multiplication of the high and low order transfer rates are different from one another, hysteresis can be imparted to characteristics when the throughput shifts either in the up direction or in the down direction. In consequence, it is possible to prevent the operation from getting unstable when the transfer rate is switched in the proximity of the threshold value.

The processing for deciding the transfer rate in the embodiment of the invention described above can be constituted as a processing program, and can be offered in the form in which it is recorded to a recording medium such as HD, DAT, FD, MO, DVD-ROM, CD-ROM, and so forth.

The embodiment of the invention takes the packet loss ratio into account in addition to throughput at each transfer rate when the transfer rate is switched, and selects and decides the reference transfer rate in the next cycle time. The embodiment also selects the transfer rate in such a fashion as to lower the reference transfer rate when the number of times of normal transmission of packets is “0”. Therefore, the embodiment can precisely decide the optimum transfer rate against drastic fluctuation of the reception sensitivity, fading occurring time-wise, and so forth.

As explained above, the invention can precisely decide the optimum transfer rate against drastic fluctuation of the reception sensitivity, fading occurring time-wise, and so forth.

1. A data transfer method for selecting an optimum transfer rate depending on a communication condition and conducting communication, comprising: when a center transfer rate of three kinds of transfer rates having transfer speeds thereof adjacent to one another and to be used in a next cycle time is selected within a certain predetermined cycle time on the basis of throughput obtained at each of said three transfer rates as a result of data transfer at said three transfer rates, said center transfer rate of said three transfer rates to be used within the next cycle time is selected in consideration of a packet loss ratio in the data transfer within the cycle time, too.

2. A data transfer method according to claim 1, wherein, when a number of packets normally transmitted is 0, said center transfer rate of said three transfer rates to be used within the next cycle time is decided to a lower order transfer rate.
